(19) United States
(12) Patent Application Publication
(10) Pub. No.: US 2006/0150805 A1
(43) Pub. Date: Jul. 13, 2006

(54) Method of automatically detecting vibrato in music

(75) Inventor: Hee Suk Pang, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/326,842

(22) Filed: Jan. 6, 2006

(30) Foreign Application Priority Data
Jan. 7, 2005 (KR) 10-2005-0001845

(51) Int. Cl. G10H 1/02; G10H 7/00

(52) U.S. Cl. 84/629

(57) ABSTRACT

A method of automatically detecting a vibrato from musical components includes calculating vibrato parameters including a vibrator rate, a vibrato extent and an intonation using a maximum likelihood estimation with respect to a musical instrument or voice frequency information, calculating a vibrato existence probability using the vibrato parameters, and determining a vibrato section based on the calculated vibrato existence probability.

Pursuant to 35 U.S.C. § 119(a), this application claims the benefit of earlier filing date and right of priority to Korean Patent Application No(s). 10-2005-0001845 filed on Jan. 7, 2005, which is hereby incorporated by reference herein in their entirety.

### BACKGROUND OF THE INVENTION

1. Field of the Invention

The present invention relates to a method of automatically detecting a vibrato from a music in an automatic music recognition system using a computer.

2. Description of the Related Art

Recognition of image, voice, and music by means of a computer has been advanced due to the technical development of signal processing and pattern recognition. In a music field, a WAV-to-MIDI conversion draws particular attention. This technology is to automatically recognize various musical components of an inputted music and provides the recognized musical components in a score form. Basic events such as a start, end, and scale change of the music can be detected using an existing technology without difficulty. However, there is still a limitation in a computer's recognition of various musical expression.

Since the music is a dedicate expression using various musical tone, various pitches and timbres, accents, and combination thereof, it is very difficult for the computer to analyze and decode the very complex musical components.

One of various musical components is a vibrato. The vibrato is one of musical techniques for making timbre luxurious, and is a repeated slight fluctuation of pitches. That is, by slightly fluctuating pitches at the same level, the music is made beautiful and emotional. The PC-based music detecting system still has difficulty in detecting the vibrato. Consequently, a man personally performs the detection.

Since the vibrato is widely used in the music, there is an increasing demand for an automatic music detecting system that can automatically detect the vibrato at high performance.

### SUMMARY OF THE INVENTION

Accordingly, the present invention is directed to a method of automatically detecting a vibrator from a music that substantially obviate one or more problems due to limitations and disadvantages of the related art.

An object of the present invention is to provide a method of automatically detecting a vibrator section in musical components.

Another object of the present invention is to provide a method of automatically detecting a vibrato section from a monophonic and polyphonic music constructed with musical instruments and voice with pitches.

A further another object of the present invention is to provide a method of automatically detecting a vibrato from musical components, including: calculating vibrato parameters including a vibrator rate, a vibrato extent and an intonation using a maximum likelihood estimation with respect to a musical instrument or voice frequency information; calculating a vibrato existence probability using the vibrato parameters; and determining a vibrato section based on the calculated vibrato existence probability.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method of automatically detecting a vibrato from a music, including: analyzing a music data to extract a vibrato parameter; calculating a vibrato existence probability using the extracted vibrato parameter; and determining a vibrato section in the music data according to the calculated vibrato existence probability value.

In another aspect of the present invention, there is provided a method of automatically detecting a vibrato from a music, including: calculating vibrato parameters including a vibrator rate, a vibrato extent with respect to a monophonic or polyphonic music, and an intonation using a maximum likelihood estimation; calculating a vibrato existence probability using the vibrato parameters; and determining a final vibrato section by verifying the calculated vibrato existence probability.

The present invention provides the method of automatically detecting the vibrato section from the monophonic music. Accordingly, the vibrato that has been difficult to detect in an existing music recognition system can be automatically detected. In the vibrato detection, it is verified whether a corresponding section is the vibrato section or not, thereby maintaining the performance and quality of the vibrato detection.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a flowchart illustrating a method of automatically detecting a vibrato according to the present invention; and

FIG. 2 is a view illustrating an example of a waveform in the method of automatically detecting the vibrato according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a method of automatically detecting a vibrato from a music according to the present invention will be described in detail with reference to the accompanying drawings.

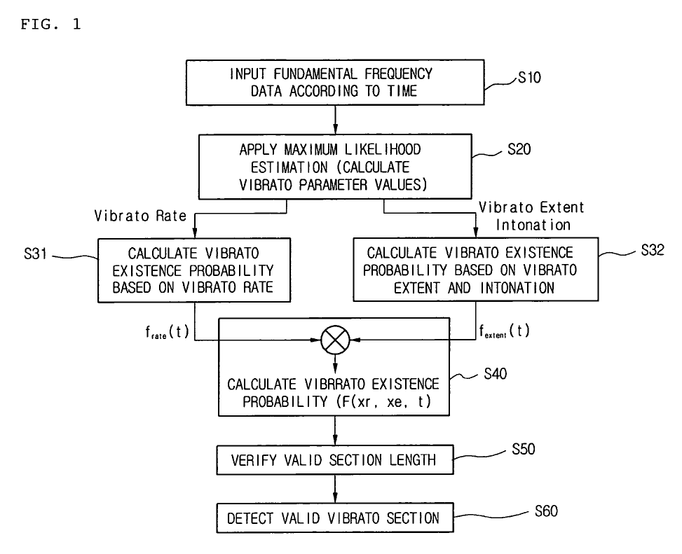

FIG. 1 is a flowchart illustrating a method of automatically detecting a vibrato according to the present invention.

In operation S10, a fundamental frequency data according to time is inputted. An automatic music recognition system receives a music through a microphone or a music resource from other acoustic storage unit, converts an analog music signal into a digital music signal (digital sample), and receives a fundamental frequency data according to time, based on a frequency analysis using the converted digital music signal.

In operation S20, vibrato parameter values are calculated by applying a maximum likelihood estimation to the received fundamental frequency data. The intended vibrato parameter values are a vibrato rate, a vibrato extent, and an intonation. The vibrato rate is a parameter representing a variation rate (degree) per unit time since the vibrato itself is a slightly fluctuating timbre. The vibrato extent is a parameter representing an amplitude of the vibrato, which means to which extent the vibrato is executed. The intonation is a parameter representing a tone and uses a medium value of values at which the fluctuation occurs at the same pitch.

The maximum likelihood estimation method is to calculate specific parameter values of musical components using the fundamental frequency data. That is, the maximum likelihood estimation method is a series of procedures to execute an algorithm expressed as L(fᵥ)=xₘᵣ^{T}E(E^{H}E)−1E^{H}Xₘᵣ using a fundamental frequency data f (m).

Here, H and T represent a complex conjugate transpose and a transpose, respectively. xₘᵣ represents a data obtained by removing an average with respect to x=[f(m) . . . f(m+M−1)]^{T}, which is an original data. Also, E=[e1 e2 e3], eₙ=[1 exp(2π ifₙ) . . . exp(2π ifₙ(M−1))^{T}, f₁=0, f₂=fᵥ/f_{frame}, f₃=−f₂. f_{frame} represents a frequency obtained by dividing a sampling frequency by a time difference between consecutive frames in an STFT, and M is a length of data processed at a time.

According to the maximum likelihood estimation method (L(fᵥ)=xₘᵣ^{T}E(E^{H}E)−1E^{H}Xₘᵣ), the vibrato rate corresponds to fᵥ that maximizes L(fᵥ) and can be found by a one-dimensional search. That is, the vibrato rate is a solution of fᵥ that maximizes L(fᵥ)

A=(Eᵥ^{H}Eᵥ)⁻¹Eᵥ^{H}x is calculated using the above values. Here, E is a matrix made using the calculated fᵥ. Assuming that (i, j)-th element of the matrix A is a_{i,j}, the intonation and the vibrato extent of the vibrato parameter values are calculated by |a11| and |a21+a31|, respectively.

In this manner, three vibrato parameter values, that is, the vibrato rate, the vibrato extent, and the intonation, are calculated. In order to remove noise component occurring in the maximum likelihood estimation method, the calculated vibrato parameter values are averaged to proper lengths. That is, a post-processing is performed for removing noise.

In operations S31 and S32, a vibrato existence probability is calculated using the calculated vibrato parameter values.

In this embodiment, the vibrato existence probability includes a first existence probability calculated based on the vibrato rate and a second existence probability calculated based on the vibrato extent and the intonation.

The vibrato rate has a subjectively most preferred range. This is reflected on the first existence probability. That is, considering the subjective preference, the first existence probability (fᵣₐₜₑ) based on the vibrato rate is defined like a modified Gaussian probability function as follows:

$${f}_{rate} ( {x}_{r} ) = exp ( \frac{- {( {x}_{r} - {f}_{v} )}^{2}}{2 {σ}^{2}} )$$

where xᵣ and fᵥ represents a measured value and a preferred value, respectively.

fᵥ is used to select a value that is appropriately fixed according to characteristics of western music or cultural difference. For example, fᵥ may be a fixed value of about 6 Hz.

Meanwhile, unlike the vibrato rate, the existence probability of the vibrato extent increases as its value is larger. This is because the vibrato extent is a parameter on which the intensity (amplitude) of the vibrato is reflected. However, there is a limitation in the actual intensity of the vibrato. The reason for this is that the excessive vibrato trespasses other pitches, so that the timbre variation that is an original object of the vibrato changes into the pitch variation.

Therefore, a normalized vibrato extent (xₑ) obtained by normalizing the vibrato extent considering the intonation is defined as xₑ=(vibratoExtent)/(Intonation), and the second existence probability (fₑₓₜₑₙₜ) associated with the normalized vibrato extent (xₑ) is defined as

$$\begin{matrix} {f}_{extent} ( {x}_{e} ) = \frac{1}{1 + exp ( - c ( {x}_{e} - {x}_{thd} )} , & for {x}_{e} < {e}_{thd} \\ {f}_{extent} ( {x}_{e} ) = 0 , & otherwise\end{matrix}$$

$$where {x}_{thd} and {e}_{thd} are threshold values .$$

In this manner, the first existence probability (fᵣₐₜₑ) is calculated based on the vibrato rate, and the second existence probability (fₑₓₜₑₙₜ) is calculated based on the vibrato extent and the intonation.

In operation S40, a final vibrato existence probability f(xᵣ, xₑ) is calculated. In this embodiment, the final vibrato existence probability f(xᵣ, xₑ) is calculated by a product of the fᵣₐₜₑ and fₑₓₜₑₙₜ. That is, f(xᵣ, xₑ)=fᵣₐₜₑ(xᵣ)·fₑₓₜₑₙₜ(xₑ).

Considering that the vibrato is a time (t) dependent function, the respective existence probabilities are expressed as
fᵣₐₜₑ(t), fₑₓₜₑₙₜ(t), f(xᵣ, xₑ, t)=fᵣₐₜₑ(xᵣ, t)·fₑₓₜₑₙₜ(xᵣ, t)

In operation S50, a valid section length is checked. That is, in detecting the vibrato section based on the vibrato existence probability, as described above, it is checked whether the vibrato existence probability of more than a predetermined level is maintained for more than a predetermined time, considering that the vibrato is a time (d) dependent function. This operation is performed for recognizing the vibrato only when the vibrato is maintained for more than a minimum time so that the audience can feel the timbre change. If the fluctuation of the sound occurs for too short time at which the audience cannot recognize the vibrato, it is not recognized as the vibrato.

In operation S60, a section passing the checking of the valid section length is finally decided as the vibrato section of the corresponding music, and the checking result is outputted.

Through the above operations, the vibrato parameter values are calculated using the maximum likelihood estimation method. Using the calculated parameter values, the respective vibrato existence probabilities are defined as f(xᵣ, xₑ, t)=fᵣₐₜₑ(xᵣ, t)·fₑₓₜₑₙₜ(xᵣ, t)·fᵣₐₜₑ(t) represents the probability based on the vibrato rate, and fₑₓₜₑₙₜ(t) represents the probability based on the vibrato extent and the intonation. Based on this, the case where the vibrato existence probability is maintained for more than a predetermined time is decided as the vibrato section.

For example, suitable coefficient values in the respective probabilities can be obtained considering aural characteristics of human being as follows.

That is, by setting fᵥ=6 Hz, σ²=1/logₑ2, c=1000, x_{thd}=0.0021186, and e_{thd}=0.03, if f(xᵣ, xₑ) is greater than 0.5, it is determined that the vibrato exists. On the contrary, if the f(xᵣ, xₑ) is less than 0.5, it is determined that the vibrato does not exist.

These values are merely an example and do not mean fixed values. These values may be modified according to musical tendency or cultural difference.

The vibrato has a predetermined time duration. Therefore, if a section where f(xᵣ, xₑ, t) exceeds a set reference value of 0.5 is maintained for more than a predetermined time, the section is recognized as the vibrato section. This is outputted as the result of the final vibrato section detection.

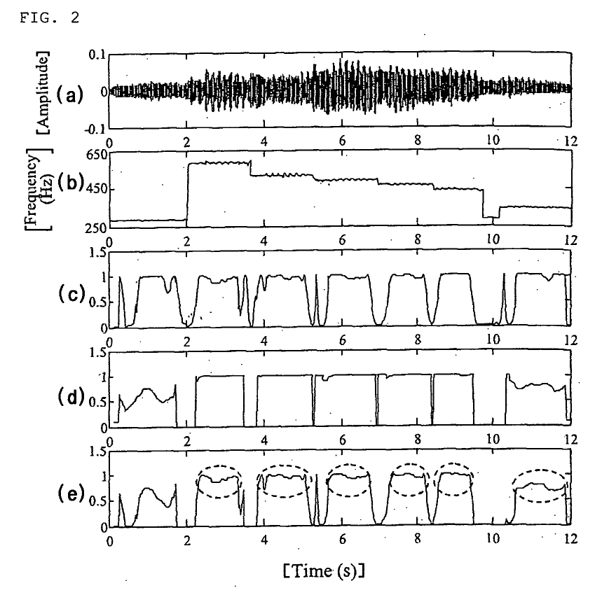

FIG. 2 illustrates the waveforms and sample values that can be exemplified in the respective operations in the automatic vibrato detecting method according to the present invention.

FIG. 2(a) illustrates a waveform of an original music. It can be seen from FIG. 2(a) that various amplitudes and frequency components coexist in the music. FIG. 2(b) illustrates the result of the fundamental frequency track obtained through the frequency analysis of the original music. It can be seen from FIG. 2(b) that slightly fluctuating sounds can be intervened in time sections.

FIG. 2(c) illustrates the vibrato existence probability (fᵣₐₜₑ(xᵣ)) based on the vibrato rate with respect to the input of the fundamental frequency data. FIG. 2(d) illustrates the vibrato existence probability (fₑₓₜₑₙₜ(xₑ)) based on the vibrato extent and the intonation with respect to the input of the fundamental frequency data.

Also, FIG. 2(e) illustrates the vibrato existence probability (f(xᵣ, xₑ)), that is, the product of the vibrato existence probability (fᵣₐₜₑ(xᵣ)) based on the vibrato rate and the vibrato existence probability (fₑₓₜₑₙₜ(xₑ)) based on the vibrato extent and the intonation.

Referring to FIG. 2(e), the vibrato existence probability values are calculated in almost most of the sections. However, the section (indicated by a dotted line) where the vibrato existence probability is greater than 0.5 and is maintained for more than a predetermined time is determined as the vibrato section and then outputted. In FIG. 2(e), the vibrato existence probability of more than 0.5 occurs in the time sections 0-2. However, since the sections are reached within a short time, it is not determined as the vibrato section.

It will be apparent to those skilled in the art that various modifications and variations can be made in the present invention. Thus, it is intended that the present invention covers the modifications and variations of this invention provided they come within the scope of the appended claims and their equivalent.

What is claimed is:

1. A method of automatically detecting a vibrato from a music, comprising:
calculating vibrato parameters including a vibrator rate, a vibrato extent and an intonation with respect to a monophonic or polyphonic music, and an intonation using a maximum likelihood estimation;
calculating a vibrato existence probability using the vibrato parameters; and
determining a final vibrato section by verifying the calculated vibrato existence probability.

2. The method according to claim 1, wherein the vibrato existence probability is determined by a product (f(xᵣ, xₑ)=fᵣₐₜₑ(xᵣ)·fₑₓₜₑₙₜ(xₑ)) of a first vibrato existence probability (fᵣₐₜₑ) calculated using the vibrato rate and a second vibrato existence probability (fₑₓₜₑₙₜ) calculated using the vibrato extent and the intonation.

3. The method according to claim 1, wherein in the verification of the vibrato, a section where the vibrato existence probability is continuous with a time length of more than a predetermined time is determined as a vibrato section.

4. The method according to claim 1, wherein the vibrato parameter values are averaged for removing noise component during the maximum likelihood estimation.

5. The method according to claim 2, wherein the first existence probability (fᵣₐₜₑ) based on the vibrato rate is defined as follows, such that a subjectively preferred range is considered,
$${f}_{rate} ( {x}_{r} ) = exp ( \frac{- {( {x}_{r} - {f}_{v} )}^{2}}{2 {σ}^{2}} )$$
where xᵣ and fᵥ represents a measured value and a preferred value, respectively.

6. The method according to claim 2, wherein the second existence probability (fₑₓₜₑₙₜ) based on the vibrato extent and the intonation defines a normalized vibrato extent (xₑ) as xₑ=(vibratoExtent)/(Intonation), and the second existence probability (fₑₓₜₑₙₜ) is defined as
$$\begin{matrix} {f}_{extent} ( {x}_{e} ) = \frac{1}{1 + exp ( - c ( {x}_{e} - {x}_{thd} )} , & for {x}_{e} < {e}_{thd} \\ {f}_{extent} ( {x}_{e} ) = 0 , & otherwise\end{matrix}$$
$$where {x}_{thd} and {e}_{thd} are threshold values .$$

7. The method according to claim 2, wherein the first existence probability (fᵣₐₜₑ) based on the vibrato rate is defined as follows, such that a subjectively preferred range is considered,
$${f}_{rate} ( {x}_{r} ) = exp ( \frac{- {( {x}_{r} - {f}_{v} )}^{2}}{2 {σ}^{2}} )$$
where xᵣ and fᵥ represents a measured value and a preferred value, respectively, and
the second existence probability (fₑₓₜₑₙₜ) based on the vibrato extent and the intonation defines a normalized vibrato extent (xₑ) as xₑ=(vibratoExtent)/(Intonation), and the second existence probability (fₑₓₜₑₙₜ) is defined as
$$\begin{matrix} {f}_{extent} ( {x}_{e} ) = \frac{1}{1 + exp ( - c ( {x}_{e} - {x}_{thd} )} , & for {x}_{e} < {e}_{thd} \\ {f}_{extent} ( {x}_{e} ) = 0 , & otherwise\end{matrix}$$
where x_{thd} and e_{thd} are threshold values, fᵥ=6 Hz, σ²=1/logₑ2, c=1000, x_{thd}=0.0021186, and e_{thd}=0.03,
when f(xᵣ, xₑ) is greater than 0.5, it is determined that the vibrato exists, and if the f(xᵣ, xₑ) is less than 0.5, it is determined that the vibrato does not exist.

8. The method according to claim 2, wherein the respective coefficient values of the vibrato existence probability are variably set depending on musical tendency and musical basis.

9. A method of automatically detecting a vibrato from a music, comprising:
analyzing a music data to extract a vibrato parameter;
calculating a vibrato existence probability using the extracted vibrato parameter; and
determining a vibrato section in the music data according to the calculated vibrato existence probability value.

10. The method according to claim 9, wherein the detection of the vibrato is performed on a monophonic and/or polyphonic music.

11. The method according to claim 9, wherein the vibrato parameter is extracted using a maximum likelihood estimation.

12. The method according to claim 9, wherein the vibrato parameter includes a vibrato rate.

13. The method according to claim 9, wherein the vibrato parameter includes a vibrato extent.

14. The method according to claim 9, wherein the vibrato parameter includes an intonation.

15. The method according to claim 9, wherein the vibrato existence probability includes a vibrato rate as the vibrato parameter.

16. The method according to claim 9, wherein the vibrato existence probability includes a vibrato extent as the vibrato parameter.

17. The method according to claim 9, wherein the vibrato existence probability includes an intonation as the vibrato parameter.

18. The method according to claim 9, wherein the vibrato existence probability uses a first vibrato existence probability calculated using a vibrato rate, and a second vibrato existence probability calculated using a vibrato extent and a vibrato intonation.

19. The method according to claim 9, wherein the vibrato existence probability is calculated by a product of a first vibrato existence probability calculated using a vibrato rate and a second vibrato existence probability calculated using a vibrato extent and a vibrato intonation.

20. The method according to claim 9, wherein a section where the vibrato existence probability is continuous with a time length of more than a predetermined time is determined as a vibrato section.
